(19) United States
(12) Patent Application Publication
(10) Pub. No.: US 2014/0365251 A1
(43) Pub. Date: Dec. 11, 2014

(54) Vacancy Rate Calculation Apparatus, Vacancy Rate Calculation System, Vacancy Rate Calculation Method and a Non-Transitory Computer-Readable Recording Medium

(71) Applicant: T&T Corporation, Tokyo (JP)

(72) Inventor: Masao Tejima, Toyko (JP)

(73) Assignee: T&T Corporation, Tokyo (JP)

(21) Appl. No.: 14/362,866

(22) PCT Filed: Mar. 22, 2013
(86) PCT No.: PCT/JP2013/058232

§ 371 Date: Jun. 4, 2014

(30) Foreign Application Priority Data
Mar. 22, 2012 (JP) 2012-066145

(51) Int. Cl. G06Q 10/02; G06Q 50/12

(52) U.S. Cl. CPC G06Q 10/02; G06Q 50/12
USPC 705/5

(57) ABSTRACT

The vacancy rate calculation apparatus is provided with a restaurant information storing part for storing table identification information, the number of customers that can be seated at each table and group information indicating a group of a plurality of tables which can be grouped. The vacancy rate calculation apparatus receives table identification information of a table at which a customer or customers is/are seated and the number of the customer or customers and determines whether or not the number of the customers exceeds the number that can be seated at the table. When it is determined that the number of the customers exceeds, the vacancy rate calculation apparatus determines whether or not another table is vacant which can be combined with the table indicated by the received table identification information. When it is determined that said another table is vacant, the vacancy rate calculation apparatus stores the table identification information of said another table at which a customer is assumed to be seated, along with the received table identification information.

### CROSS-REFERENCE TO RELATED APPLICATION

This application is the national phase under 35 U.S.C. §371 of PCT International Application No. PCT/JP2013/58232 which has an International filing date of Mar. 22, 2013 and designated the United States of America.

### FIELD

The present invention relates to a vacancy rate calculation apparatus, a vacancy rate calculation system, a vacancy rate calculation method and a computer program for calculating a vacancy rate of tables placed in a restaurant.

### BACKGROUND

A vacancy rate controlling device has been provided which displays an image of each of tables provided in a restaurant on a display and displays whether or not each table is vacant, so that not only the seating state of each table but also the position of each table and the surrounding condition thereof can easily be grasped (Japanese Patent Application Laid-Open No. 2000-194781, for example).

Also, an ordering device and a portable order terminal thereof have been proposed, which are capable of surely guiding a customer to a vacant table set ready without guiding the customer to a table during preparation and capable of taking an order with a POS (Point Of Sale) system used in an restaurant or the like (Japanese Patent Application Laid-Open No. 2002-123870, for example).

On the other hand, the present applicant is considering a system which controls the occupancy state of tables in a restaurant by using information in an OES (Order Entry System). When taking an order from a customer who is seated at a table, an order receptionist of the restaurant inputs the table number and the number of the customers into a handy terminal. The OES calculates the vacancy rate of the tables placed at the restaurant by storing the inputted table number and the number of customers, thereby controlling the table occupancy state or the like.

### SUMMARY

However, when receiving customers with multiple tables combined, for example, receiving eight customers at two tables, each having four seats and being arranged side-by-side, an order receptionist needs to input the number of each table and the number of the customers at each table in a handy terminal, which takes a longer time for the input operation.

Specifically, when the restaurant is crowded, only the table number and the number of the customers for one of the tables are inputted for saving the time. In addition, inputting the table numbers of all the tables with a large number of customers is usually omitted at a restaurant which has a basic policy of not giving unnecessary work to its employees, such as an order receptionist, in order to reduce cost. When information is inputted in such a manner, even a table with customers may be processed as a vacant table, thereby making it difficult to control the vacant state of the tables.

The present invention is made in view of the above circumstances. An object of the invention is to provide a vacancy rate calculation apparatus, a vacancy rate calculation system, a vacancy rate calculation method and a computer program, which can calculate a vacancy rate in a restaurant by only inputting table identification information of one table among a plurality of tables at which customers are to be seated and the number of the customers, when receiving the customers with a plurality of tables combined.

A vacancy rate calculation apparatus according to the present invention is characterized by comprising:

a restaurant information storing part for storing table identification information identifying each of a plurality of tables placed at a restaurant and the number of customers that can be seated at each of the plurality of tables, the table identification information and the number of customers that can be seated at each of the plurality of tables being associated with each other;

a receiving part for receiving table identification information indicating a table at which a customer or customers is/are seated and seated number information indicating the number of the customer or customers; and

a table occupancy state storing part for storing the table identification information and the seated number information received by the receiving part,
the vacancy rate calculation apparatus calculating a vacancy rate of the tables based on the information stored in the restaurant information storing part and the table occupancy state storing part, wherein

the restaurant information storing part stores group information indicating a group of a plurality of tables in which the plurality of tables are combined for allowing a plurality of customers to be seated together,
the vacancy rate calculation apparatus further comprising:
means for determining whether or not the number of customers indicated by the seated number information received by the receiving part is equal to or less than the number of customers that can be seated at the table indicated by the received table identification information based on the information stored in the restaurant information storing part;
means for determining, when it is determined that the number of customers exceeds the number of customers that can be seated, whether or not another is vacant which can be combined with the table indicated by the received table identification information based on the group information stored in the restaurant information storing part and the information stored in the table occupancy state storing part; and
means for causing, when it is determined that said another table which can be combined with is vacant, the table occupancy state storing part to store table identification information identifying said another table at which a customer is assumed to be seated, along with the received table identification information.

A vacancy rate calculation apparatus according to the present invention is characterized by comprising:

means for determining whether or not another customer is already seated at the table indicated by the table identification information received by the receiving part based on the table identification information stored in the table occupancy state storing part;

means for determining, when it is determined that another customer is already seated, whether or not a vacant table is present which can be combined with the table indicated by the table identification information received by the receiving part based on the grouping information and the table identification information stored in the table occupancy state storing part;

means for exchanging, when it is determined that the vacant table is present, the table identification information indicating said another table stored in the table occupancy state storing part for the table identification information indicating the vacant table; and

means for causing the table occupancy state storing part to store the table identification information and the seated number information received by the receiving part.

A vacancy rate calculation system according to the present invention is characterized by comprising:

the vacancy rate calculation apparatus;

an order entry system for accepting table identification information indicating a table at which a customer or customers is/are seated, the seated number information indicating the number of the customer or customers, and an order of food and/or drink; and

a communication device for obtaining the table identification information and the seated number information from the order entry system and transmitting the obtained table identification information and the seated number information to the vacancy rate calculation apparatus.

A vacancy rate calculation method for calculating a vacancy rate of tables according to the present invention is characterized by using:

a restaurant information storing part for storing table identification information identifying each of a plurality of tables placed at a restaurant and the number of customers that can be seated at each the plurality of tables, and group information indicating a group of the plurality of tables in which the plurality of tables are combined for allowing a plurality of customers to be seated together; and

a table occupancy state storing part for storing table identification information indicating a table at which a customer or customers is/are seated and seated number information indicating the number of the customer or customers,

the vacancy rate calculation method comprising the steps of:
receiving table identification information indicating a table at which a customer or customers is/are seated and the seated number information indicating the number of the customer or customers;
determining whether or not the number of customers indicated by the received seated number information is equal to or less than the number of customers that can be seated at the table indicated by the received table identification information based on the information stored in the restaurant information storing part;
determining, when it is determined that the number of customers indicated by the seated number information exceeds the number of customers that can be seated, whether or not another table is vacant which can be combined with the table indicated by the received table identification information based on the group information stored in the restaurant information storing part and the information stored in the table occupancy state storing part; and
causing, when it is determined that said another table which can be combined with is vacant, the table occupancy state storing part to store table identification information identifying said another table at which a customer is assumed to be seated, along with the received table identification information.

A computer program according to the present invention is characterized by causing a computer to calculate a vacancy rate of tables, the computer comprising:

a restaurant information storing part for storing table identification information identifying each of a plurality of tables placed at a restaurant and the number of customers that can be seated at each of the plurality of tables, and group information indicating a group of the plurality of tables in which the plurality of tables are combined for allowing a plurality of customers to be seated together;

a receiving part for receiving table identification information indicating a table at which a customer or customers is/are seated and seated number information indicating the number of the customer or customers; and

a table occupancy state storing part for storing the table identification information and the seated number information received by the receiving part,

the computer program causing the computer to function as:
means for determining whether or not the number of customers indicated by the seated number information received by the receiving part is equal to or less than the number of customers that can be seated at the table indicated by the received table identification information based on the information stored in the restaurant information storing part;
means for determining, when it is determined that the number of customers indicated by the seated number information indicated by the seated number information exceeds the number of customers that can be seated, whether or not another table is vacant which can be combined with the table indicated by the received table identification information based on the group information stored in the restaurant information storing part and the information stored in the table occupancy state storing part; and
means for causing, when it is determined that said another table which can be combined with is vacant, the table occupancy state storing part to store table identification information identifying said another table at which a customer is assumed to be seated, along with the received table identification information.

In the present invention, the vacancy rate calculation apparatus receives table identification information indicating a table at which a customer is seated, and seated number information indicating the number of seated customers. The table identification information and the seated number information are transmitted from an external device. When the number of customers indicated by the seated number information exceeds the seating capacity of the table indicated by the table identification information, it is considered that the customers are received with a plurality of tables combined. The restaurant information storing part stores group information indicating a group of a plurality of tables in which the plurality of tables are combined for allowing a large number of customers to be seated together. Therefore, by using the group information, it is possible to presume another table being combined with the table indicated by the received table identification information. On the assumption that the customers are seated at the table indicated by the received table identification information and the above-described another table, the vacancy rate calculation apparatus causes the table occupancy state storing part to store table identification information of each of the tables.

In the present invention, after receiving customers with a plurality of tables combined, in a case where the same table identification information as that of another table which is assumed to be occupied by the customers is received, that is, the other combined table is incorrectly assumed, the vacancy rate calculation apparatus changes the combination of the tables to the combination with another available table for consistency.

According to the present invention, when receiving customers with a plurality of tables combined, it is possible to calculate the vacancy rate in a restaurant by only inputting table identification information indicating one of the tables at which the customers are to be seated and the number of the customers.

The above and further objects and features will more fully be apparent from the following detailed description with accompanying drawings.

### BRIEF DESCRIPTION OF THE DRAWINGS

FIG. 1 is a block diagram illustrating a configuration example of a vacancy rate calculation system according to an embodiment of the present invention;

FIG. 2 is a block diagram illustrating a configuration example of a vacancy rate calculation apparatus;

FIG. 3 is a diagrammatic representation conceptually illustrating a plurality tables provided in a restaurant;

FIG. 4 is an explanatory view conceptually illustrating an example of a record layout of a restaurant information database;

FIG. 5 is an explanatory view conceptually illustrating an example of a record layout of a table occupancy state database;

FIG. 6 is a flowchart illustrating a procedure of a controlling part for deciding and changing an occupancy table, and calculation of a vacancy rate;

FIG. 7 is a flowchart illustrating a procedure of a controlling part for deciding and changing an occupancy table, and calculation of a vacancy rate;

FIG. 8 is a diagrammatic representation illustrating a procedure of deciding and changing an occupancy table;

FIG. 9 is an explanatory view illustrating details of an occupancy table in a procedure of deciding and changing the table.

FIG. 10 is a diagrammatic representation illustrating a procedure of deciding and changing an occupancy table;

FIG. 11 is an explanatory view illustrating details of an occupancy table in a procedure of deciding and changing the occupancy table;

FIG. 12 is a diagrammatic representation illustrating an example of a display screen for indicating a vacancy rate or the like.

### DETAILED DESCRIPTION OF NON-LIMITING EXAMPLE EMBODIMENTS

The present invention is described below with reference to the drawings illustrating an embodiment thereof.

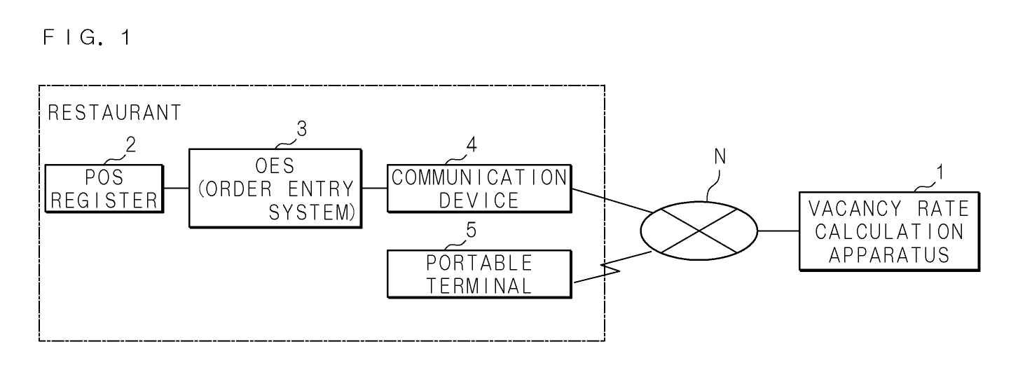

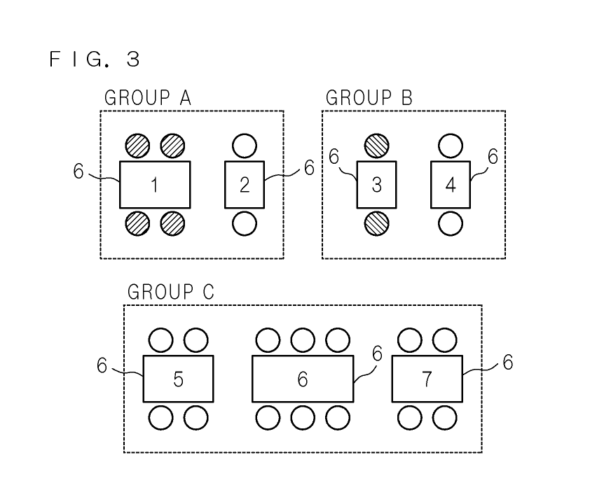

FIG. 1 is a block diagram illustrating a configuration example of a vacancy rate calculation system according to an embodiment of the present invention. The vacancy rate calculation system according to the embodiment of the present invention comprises a vacancy rate calculation apparatus 1 which calculates a vacancy rate of a plurality of tables 6 (refer to FIG. 3) placed in a restaurant and is connected with or without wire to a communication device 4 and a portable terminal 5 of the restaurant via a communication network N. Also, a POS register 2 and an OES (order entry system) 3 are installed in the restaurant and the communication device 4 is connected with or without wire to the OES 3.

The OES 3 has an OES control device, a handy terminal and a printer which are not illustrated. The handy terminal is a device for receiving ordering information, such as items from a menu, the quantity of items, table identification information, and the number of customers seated, and wirelessly transmitting the received ordering information to the OES control device.

The OES control device receives the ordering information transmitted by the handy terminal with an antenna, and transmits the received ordering information to the printer. Also, the OES control device transmits a whole or a part of the received ordering information to the communication device in response to a request from the communication device. Specifically, when receiving ordering information from a new customer or customers, the OES control device transmits table identification information, seated number information, and seated time information which indicates the time when the customer or customers is/are seated at a table 6, to the communication device 4 which is described later.

The printer is placed in a kitchen, which receives the ordering information transmitted from the OES control device and prints the contents of the order.

An order receptionist takes an order of food and drink from a customer or customers and inputs the ordering information to the handy terminal. Specifically, the order receptionist inputs table identification information for identifying the table 6 at which the customer or customers is/are seated, for example, the table number and the number of customers, and subsequently inputs items from a menu and the quantity of the ordered items. Here, when receiving customers with a plurality of tables 6 combined, for example, when receiving ten customers by arranging a table 6 having six seats and a table 6 having four seats side-by-side, the order receptionist only needs to input the table number of one of the tables and the number of the customers, which is ten, to the handy terminal. When the ordering information is fixed, the handy terminal transmits the ordering information to the OES control device.

The OES control device receives the ordering information transmitted from the handy terminal and stores it. The OES control device also transmits the received ordering information to the printer and causes the printer to print the contents of the order. A chef performs cooking based on the printed ordering information. Moreover, in response to a request from the POS register 2, the OES control device transmits the ordering information and an order slip number to the POS register 2.

The POS register 2 is connected to the OES control device through a LAN. The POS register 2 obtains the ordering information from the OES 3 for performing an accounting process and outputs a receipt.

The communication device 4 is a computer having a CPU (Central Processing Unit), which includes a first interface transmitting and receiving information to and from the OES 3 and a second interface transmitting and receiving information to and from the vacancy rate calculation apparatus 1 via the communication network N. The communication device 4 has a function of obtaining table identification information, seated number information and seated time information or the like via the first interface, and transmitting each of the obtained information to the vacancy rate calculation apparatus 1 via the second communication interface.

The portable terminal 5 is a terminal, for example, a tablet on which a touch panel is mounted, a mobile phone, a PDA or the like, which can wirelessly communicate with the vacancy rate calculation apparatus 1 connected to the communication network N.

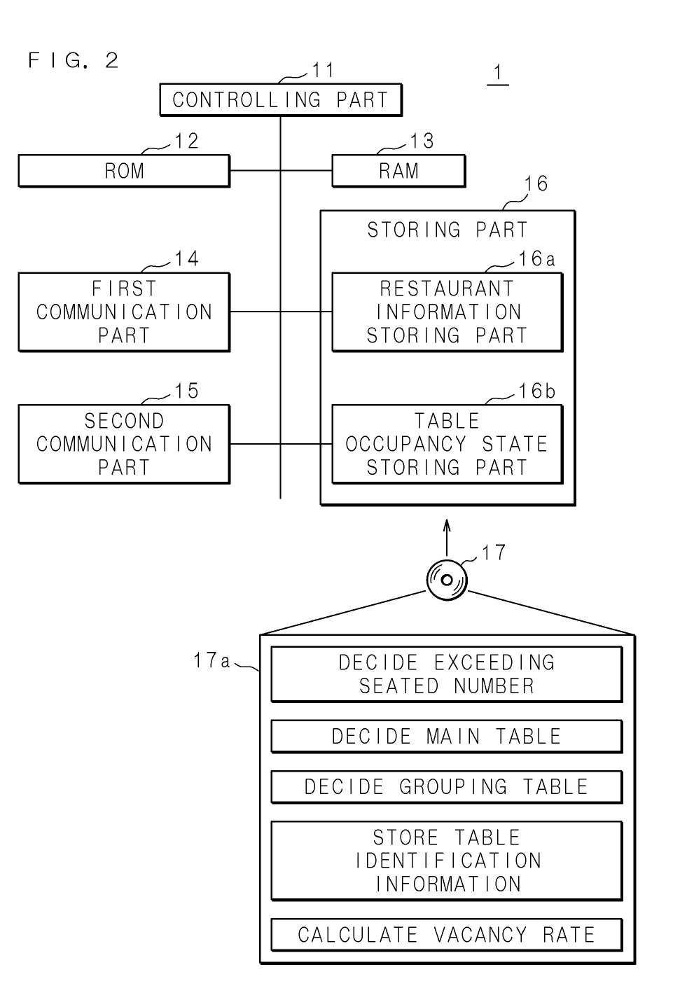

FIG. 2 is a block diagram illustrating a configuration example of the vacancy rate calculation apparatus 1. The vacancy rate calculation apparatus 1 is a computer, which includes a controlling part 11, for example a CPU, which controls the operation of each configuration part of the vacancy rate calculation apparatus 1. To the controlling part 11, a ROM 12, a RAM 13, a first communication part (receiving part) 14, a second communication part 15 and a storing part 16 are connected via bus.

The ROM 12 is a nonvolatile memory, such as a mask ROM or an EEPROM, which stores a control program necessary for operating a computer.

The RAM 13 is a volatile memory, such as a DRAM or a SRAM, which temporarily stores various types of data generated when computing processing is executed in the controlling part 11.

The first communication part 14 is an interface which communicates with the communication device 4 installed in a restaurant for transmitting and receiving information necessary for calculating the vacancy rate of the tables 6. The transmission and reception of various types of information by the first communication part 14 is controlled by the controlling part 11. Specifically, the first communication part 14 receives information transmitted from the communication device 4 installed in the restaurant, specifically, table identification information indicating the table 6 at which a customer is seated and the seated number information indicating the number customers.

The second communication part 15 is an interface which transmits information such as a vacancy rate to the portable terminal 5 in response to a request from the portable terminal 5 of a restaurant. The transmission and reception of various types of information by the second communication part 15 is controlled by the controlling part 11.

The storing part 16 is a hard disk, a nonvolatile semiconductor memory or the like, which stores a computer program 17a for causing a computer to function as the vacancy rate calculation apparatus 1. The storing part 16 has a restaurant information storing part 16a and a table occupancy state storing part 16b. Details of the data to be stored in the restaurant information storing part 16 and the table occupancy state storing part 16b are described later.

As for the computer program 17a, by the controlling part 11 controlling the operating of an external storing device (not illustrated), the computer program 17a is read out from a recording medium 17, such as a CD (compact Disc)-ROM, a DVD (Digital Versatile Disc)-ROM or a BD (Blu-ray (Registered-mark) Disc), in which the computer program 17a is recorded in a computer-readable manner, and is stored in the storing part 16. Needles to say, an optical disc and an optical disc drive are examples of the recording medium 17 and an external storing device, respectively. It may be possible to configure that the computer program 17a is recorded in a computer readable manner in a flexible disc, a magnetic optical disc, an external hard disk or a semiconductor memory, and is read out by the external storing device. The computer program 17a of the present invention may also be downloaded from an external computer (not illustrated) connected to the communication network N.

The restaurant information storing part 16a configures a restaurant information database in which table identification information for identifying each of the tables 6 placed in a restaurant is associated with the number of customers which can be seated at each table 6. Also, the restaurant information storing part 16a stores group information indicating a group of the tables 6 that are combined for allowing a large number of customers to be seated together.

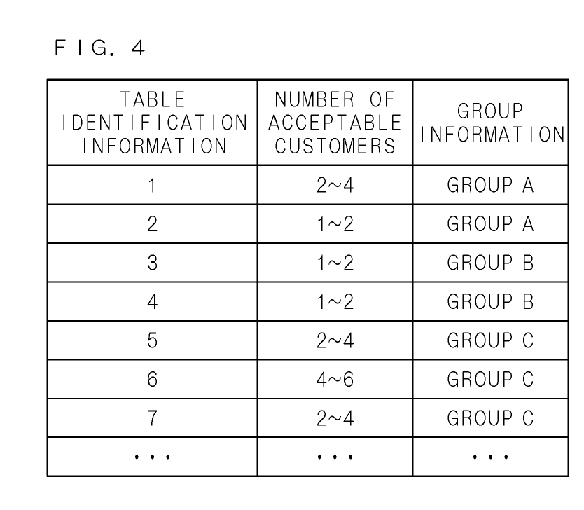

FIG. 3 is a diagrammatic representation conceptually illustrating a plurality tables 6 provided in a restaurant while FIG. 4 is an explanatory view conceptually illustrating an example of a record layout of the restaurant information database. As illustrated in FIG. 3, in the present embodiment, the restaurant has three four-seat tables 6, three two-seat tables 6, and one six-seat table 6. A number labeled for each of the tables 6 is for identifying each of the tables. A database table (file) of the restaurant information database is configured with a plurality of columns (field), for example, a column of “table identification information,” a column of “the number of acceptable customers,” a column of “group information” or the like, and each row (record) has information corresponding to each column.

The column of “table identification information” stores table identification information for identifying each of the tables 6 placed in the restaurant. For example, when the restaurant has seven tables 6, the numbers from 1 to 7 are stored.

The column of “the number of acceptable customers” stores the number of customers that can be seated at each of the tables 6. Although an upper limit and a lower limit of the number of the customers are stored in the present embodiment, only an upper limit may be stored.

The column of “group information” stores group information which indicates groups of tables 6 which can be combined with each other when receiving a large number of customers to be seated together. For example, as illustrated in FIG. 3, when it is possible to combine a table 6 labeled with No. 1 with a table 6 labeled with No. 2, “group A” is stored as group information of each of the tables 6. Similarly, when it is possible to combine a table 6 labeled with No. 3 with a table labeled with No. 4, or to combine the tables 6 labeled with No. 5 to No. 7 with each other, “group B” or “group C” are stored as group information of each of the tables 6, respectively.

Various types of information to be stored in the restaurant information database is, for example, inputted to the communication device 4 of the restaurant, and transmitted from the communication device 4 to the vacancy rate calculation apparatus 1, and the controlling part 11 of the vacancy rate calculation apparatus 1 stores the information in the restaurant information storing part 16a.

In the present embodiment, an example is described that a vacancy rate of tables in a restaurant is controlled and calculated. When vacancy rates of tables 6 in a plurality of restaurants are controlled, the restaurant information database further includes fields which store information for identifying each of a plurality of companies as well as each of a plurality of the restaurants possessed by each of the companies.

The above-mentioned record layout is an example and the configuration is not limited as long as the substantive contents can be stored.

The table occupancy state storing part 16b configures a table occupancy state database which stores table identifying information and seated number information which are received by the first communication part 14.

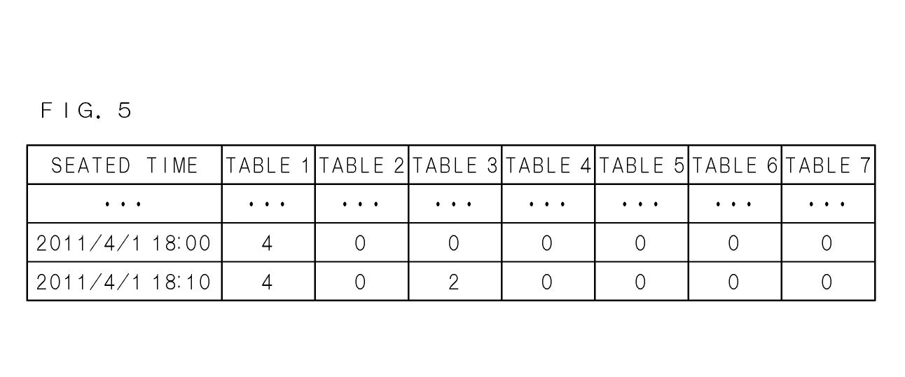

FIG. 5 is an explanatory view conceptually illustrating an example of a record layout of a table occupancy state database. A table of the table occupancy state database is configured with multiple columns, such as a column of “seated time” and a column of “table 1” through a column of “table 7”, and each of the rows has information corresponding to each of the columns.

The column of “seated time” stores seated time information transmitted from the communication device 4 of the restaurant. The seated time information indicates the time when the first order from the customers seated at a table 6 is received.

The column of “table 1” stores the number of customers seated at the table 6 labeled with No. 1. The columns from “table 2” to “table 7” also store information in a similar manner. When table identifying information and seated number information transmitted from the communication device 4 are received, the controlling part 11 of the vacancy rate calculation apparatus 1 stores the seated number information to any one of the column of “table 2” to the column of “table 7”, which corresponds to the table 6 indicated by the table identifying information. A process is described later for a case where the number indicated by the seated number information exceeds the number of customers who can be seated at the table 6 identified by the table identifying information.

The above-mentioned record layout is an example. The configuration is not limited thereto as long as the substantive contents can be stored.

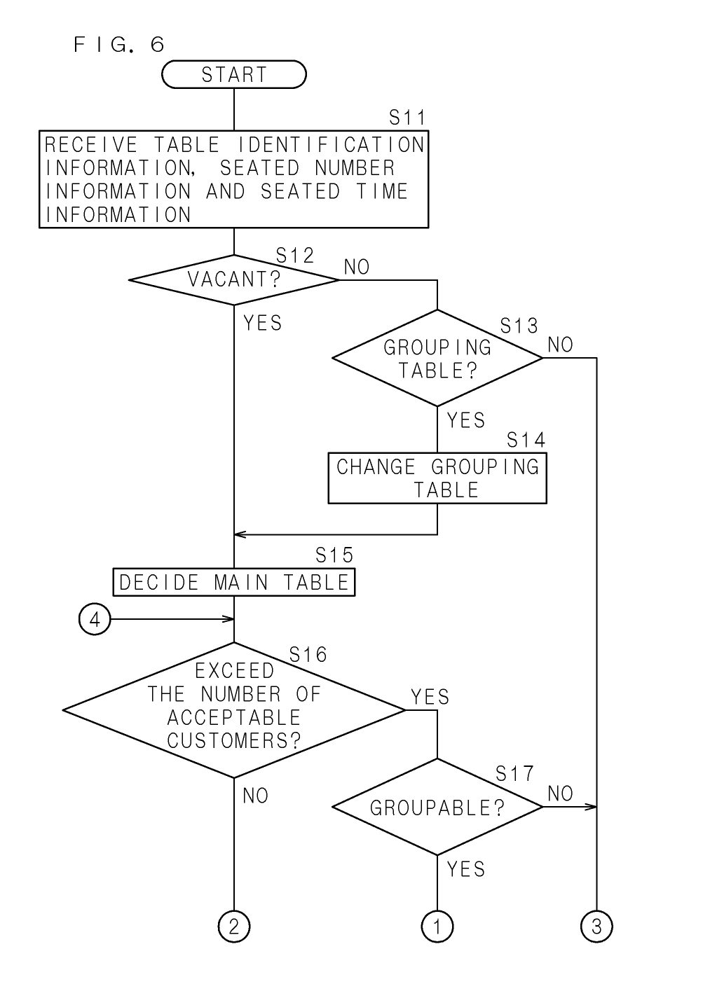

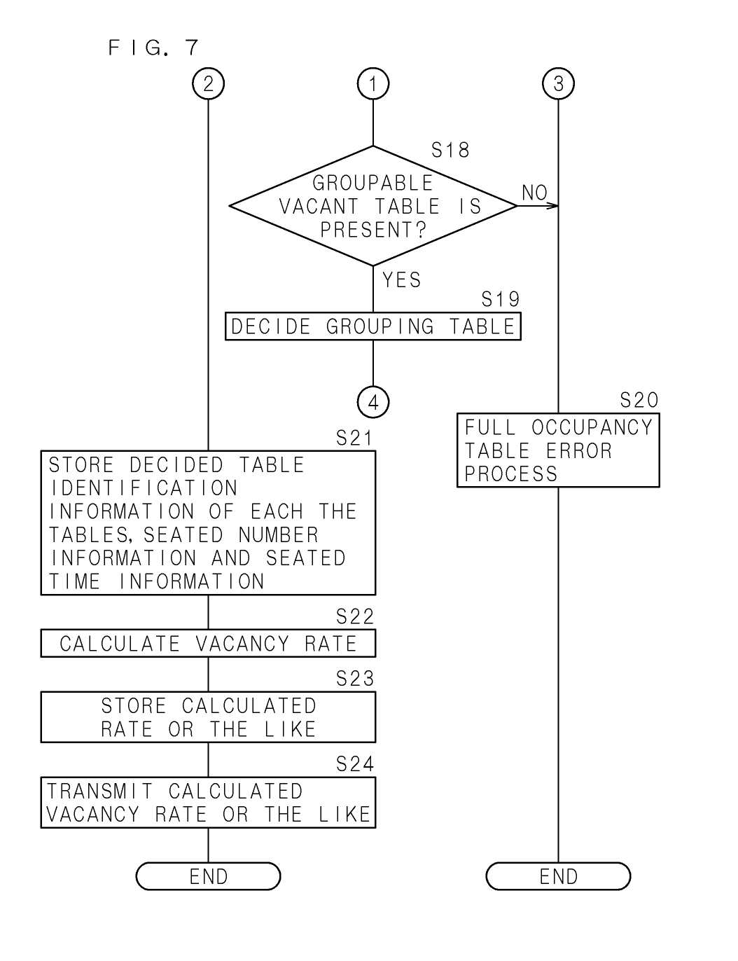

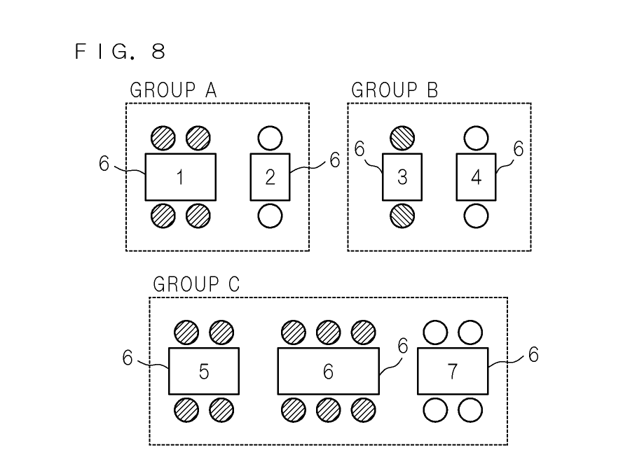

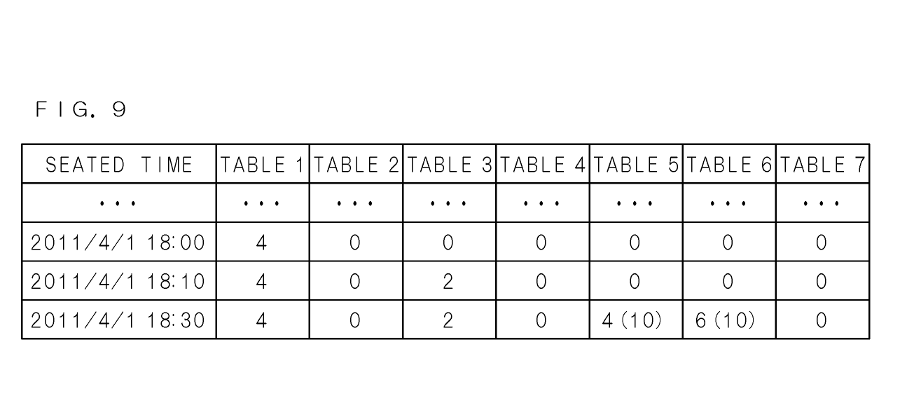

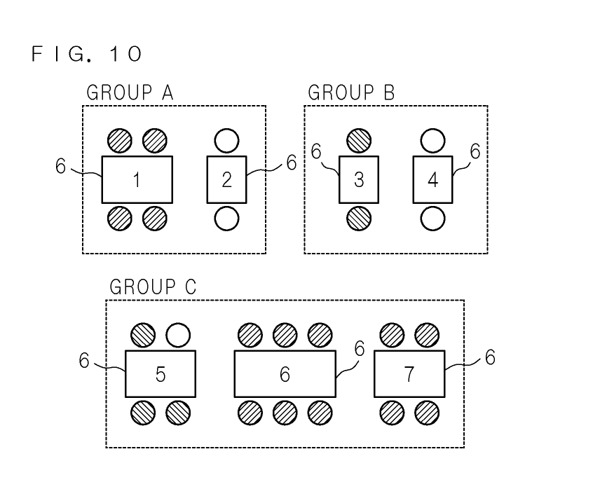

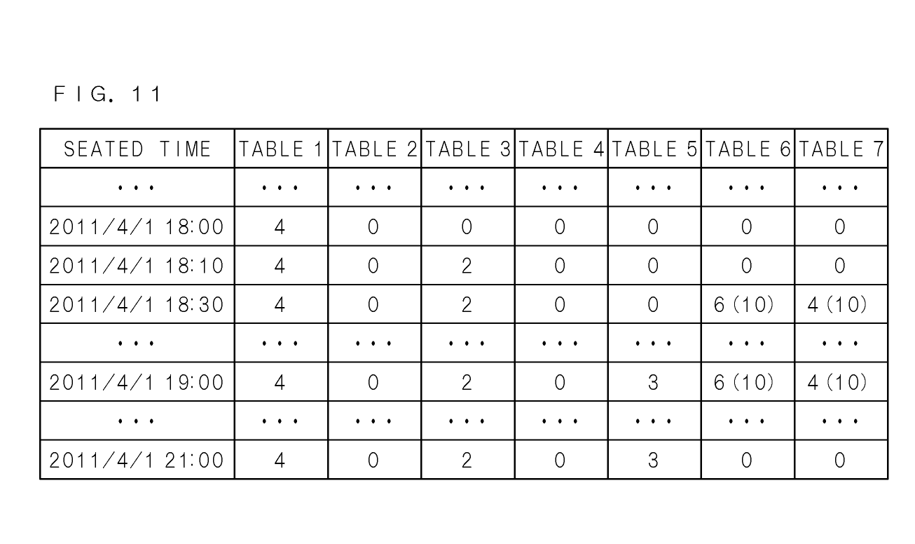

FIGS. 6 and 7 are flowcharts illustrating a procedure of the controlling part 11 for deciding and changing an occupancy table, and calculating a vacancy rate. FIGS. 8 and 10 are diagrammatic representations illustrating a procedure of deciding and changing an occupancy table. FIGS. 9 and 11 are explanatory views illustrating details of an occupancy table in a procedure of deciding and changing the occupancy table.

The communication device 4 in a restaurant obtains table identification information, seated number information and seated time information from the OES 3, and transmits each of the obtained information to the vacancy rate calculation apparatus 1. The vacancy rate calculation apparatus 1 receives the table identification information, the seated number information and the seated time information transmitted from the communication device 4 (step S11). Specifically, the table identification information and the seated number information indicate the table 6 at which customers are seated and the number of the customers. It may be so configured that the communication device 4 transmits table identification information, seated number information, seated time information and the like, which are obtained when the customers make the first order, to the vacancy rate calculation apparatus 1, and the communication device 4 does not transmit table identification information or the like, which is obtained when the customers make an additional order, to the vacancy rate calculation apparatus 1.

Subsequent to step S11, the controlling part 11 determines whether the table 6 indicated by the received table identification information is vacant or not, based on the information stored in the table occupancy state storing part 16b (step S12). More specifically, the controlling part 11 refers to the table occupancy state database illustrated in FIG. 5, and determines whether the latest seated number information which corresponds to the received table identification information is zero or not. If the seated number is zero, it is determined as vacant.

When it is determined as vacant (step S12: YES), the controlling part 11 decides the table 6 indicated by the received table identification information as a main table (step S15). The main table means a table 6 with a table number inputted to the handy terminal when accepting the customers and receiving an order, and is used for controlling the order from the customers. In a case where a plurality of customers can be seated at a table 6, the table 6 itself becomes a main table. In a case where a plurality of customers cannot be seated at a table 6, the customers are seated at a plurality of tables 6 which can be combined with one another. In this case, the order receptionist decides one of the tables 6 as a main table and inputs the table number to the handy terminal. In this case, the table 6 which the order receptionist decided and inputted the table number thereof is decided as a main table. As to a procedure in a case where the table is not vacant is described after describing steps S 16 to 19 which concern grouping.

Then, the controlling part 11 determines whether or not the number of customers indicated by the seated number information received at step S11 exceeds the total sum of customers that can be seated at the decided main table and a groping table which is described later (step S16). For example, as illustrated in FIGS. 8 and 9, in a case where a group of ten customers are received at 18:30, when the controlling part 11 receives table identification information for the table labeled with No. 6 and the seated number information indicating ten customers, it is determined that the number of ten customers exceeds the number of acceptable customers at the table labeled with No. 6. When executing step S16 first, a grouping table has not been decided. Accordingly, it is determined whether or not the number indicated by the seated number information received at step S11 exceeds the number of customers that can be seated at the main table.

When it is determined that the number of customers indicated by the seated number information exceeds the total sum of customers that can be seated at the decided main table and a groping table which is described later (step S16: YES), the controlling part 11 determines, based on data in the restaurant information storing part 16a, whether or not the main table is the table 6 which can be grouped (step S17). That is, it is determined whether or not another table 6 is present which can be combined with the main table such that a large number of customers to be seated together. More specifically, the controlling part 11 refers to the restaurant information database and determines whether or not group information corresponding to the main table is stored.

When it is determined that a table 6 which can be grouped is not present (step S17: NO), the controlling part 11 executes processing of reporting an error indicating that tables 6 are occupied (step S20). When it is determined that a table 6 which can be grouped is present (step S17: YES), the controlling part 11 determines whether or not a table 6 which is vacant and can be grouped is present (step S18). A table 6 which can be grouped with the main table means a table 6 with which the same group information as that of the main table is associated. For example, in a case where the main table is a table 6 labeled with No. 6, a table 6 labeled with No. 5 and a table labeled with No. 7 are the tables 6 which can be grouped with the main table. Among the tables 6 which can be grouped, a vacant table 6 can be determined based on information stored in the table occupancy state database.

When it is determined that a table 6 which is vacant and can be grouped is present (step S18: YES), the controlling part 11 decides one table 6 which is vacant and can be grouped as a grouping table for the main table (step S19), and returns the processing to Step S16. In a case where a plurality of tables which are vacant and can be grouped are present, any one of the tables 6 can be decided as a grouping table. For example, according to an example shown in FIG. 8, a table 6 labeled with No. 5 and a table labeled with No. 7 are present as tables 6 which can be grouped with the main table labeled with No. 6. Here, the table 6 labeled with No. 5 is decided as a grouping table. A grouping table means a table 6 which is likely to be combined with the main table when receiving a large number of customers. When the processing is returned to step S16, as described above, the controlling part 11 calculates the total sum of the number of customers can be seated at the main table and the number of customers that can be seated at the groping table decided at step S19, then the controlling part 11 executes processing of determining whether or not the number indicated by the seated number information received at step S11 exceeds the total sum.

When it is determined that a table 6 which is vacant and can be grouped is not present (step S18: NO), the controlling part 11 executes processing of reporting an error indicating that the tables 6 are occupied (step S20).

Here, returning to FIG. 6, processing of steps S13, 14 are described. When it is determined that the table is not vacant at step S12 (step S12: NO), the controlling part 11 determines whether or not the table 6 indicated by the table identification information received at step S11 is a grouping table (step S13). When it is determined as a grouping table (step S13: YES), the controlling part 11 changes the grouping table (step S14). For example, as illustrated in FIG. 8, in a case where it is assumed that the tables labeled with No. 5 and 6 have already been occupied, if information indicating that three customers are seated at the table labeled with No. 5 is received, the assumption that the grouping table is the table labeled with No. 5 is incorrect. Therefore, as illustrated in FIGS. 10 and 11, the table 6 to be grouped with the main table labeled with No. 6 is changed to the table labeled with No. 7.

More specifically, the controlling part 11 specifies tables 6 which can be grouped with the table 6 indicated by the table identification information received at step S11 based on data in the restaurant information storing part 16a, and further specifies a vacant table 6 among the specified tables 6 based on data in the table occupancy state storing part 16b. Then, the controlling part 11 changes the number of the customers which is registered in the table occupancy state storing part 16b, being associated with the table 6 indicated by the table identification information received at step S11, to zero. Then, the controlling part 11 changes the number of the customers so as to be associated with another specified table 6, which is vacant and can be grouped. By this processing of changing, the table 6 indicated by the table identification information becomes vacant.

That is, in a case where it is determined that the table is not vacant in step S12, it is assumed that the previous assumption made for a grouping table to be combined with a main table for customers was incorrect. Thus, processing is executed for changing the grouping table to be combined with the main table and for returning the status of the previous grouping table to be vacant.

When it is determined that the tale 6 is not a groping table at step S13 (step S13: NO), the controlling part 11 executes the processing of reporting an error indicating that the tables 6 are occupied (step S20).

Next, step S21 in FIG. 7 is described.

After deciding the main table and the groping table, and when it is determined that the number of customers indicated by the seated number information does not exceed the total sum of the number of customers that can be seated at the main table and the grouping table (step S16: NO), the controlling part 11 causes the table occupancy state storing part 16b to store the table identification information for the decided main table and the grouping table, the seated number information and the seated time information (steps S21). Here, when causing the table occupancy state storing part 16b to store the table identification information for the main table and the grouping table, how to seat the customers becomes an issue. It may be possible to have one of the tables fully occupied or to seat the customers equally to the tables within the range of the seating capacity of each of the tables.

Next, the controlling part 11 calculates, based on the information stored in the restaurant information storing part 16a and the table occupancy state storing part 16b, a vacancy rate or the like (step S22), and stores the calculated rate in the storing part 16 (step S23). In step S22, in addition to the vacancy rate, the total number of the customers currently present in the restaurant, the number of tables seated by the customers, and an occupancy rate may be calculated. An occupancy rate means a ratio of the actual number of the customers seated to the seating capacity of each the tables 6.

It may also be possible to configure that the communication device 4 obtains from the OES3 and transmits to the vacancy rate calculation apparatus 1a billing amount, which is computed by an accounting process through the POS register 2, charged to each customer, and information of the date and time of the accounting process. The vacancy rate calculation apparatus 1 receives the information transmitted from the communication device 4 and, based on the received information, accumulates the sales of a day or a month and stores the information.

Moreover, the communication device 4 may be so configured that, each time when receiving an order from each customer, the communication device 4 obtains a billing amount according to the order from the OES 3 before an accounting process is performed, and transmits the obtained billing amount to the vacancy rate calculation apparatus 1. The vacancy rate calculation apparatus 1 receives the information transmitted from the communication device 4 and, based on the received information, accumulates the predicted sales of the day and stores it.

In response to a request from the communication device 4 or the portable terminal 5, the controlling part 11 transmits information of the calculated vacancy rate or the like to the communication device 4 (Step S24). The communication device 4 and the portable terminal 5 receive the information of the calculated vacancy or the like transmitted from the vacancy rate calculated device 1, and based on the received information, displays the vacancy rate or the like. A screen of the communication device 4 or the portable terminal 5, on which information is displayed based on the information transmitted at step S24, is referred to as a display screen for indicating a vacancy rate or the like. Also, the vacancy rate calculation apparatus 1 transmits information of a vacancy rate or the like to an information providing device (not illustrated) which is an external device and provides information regarding a restaurant and a vacancy rate. Based on the information transmitted from the vacancy rate calculation apparatus 1, the information providing device can widely provide information regarding the occupancy state of the restaurant, such as whether or not the restaurant has vacant seats, being crowded or fully occupied, a turnover of customers or the like. Needles to say, it is possible to generate information of the restaurant based on the information of a vacancy rate or the like and transmit the generated information to general users directly.

Here, an example of calculating the vacancy rate at the present time point is described. It may also be possible to calculate the vacancy rate predictively. The storing part 16 stores an average period of time during which customers stay at tables. The average time corresponds to, for example, a predetermined value stored in the storing part 16 in advance (hereinafter, referred to as a predetermined staying duration). The controlling part 11 specifies table identification information of a table which is expected to be vacant at a time point later than the present time based on the information and the predetermined staying duration stored in the table occupancy state information storing part 16a. For example, the controlling part 11 adds the predetermined staying duration to the time when a customer is seated. Then, the controlling part 11 compares the time obtained by adding the predetermined staying duration with a specified time later than the present time point, for example, 30 minutes or 60 minutes after the present time point. How to set the specified time is not particularly limited. When the controlling part 11 determines the time obtained by adding the predetermined staying duration is earlier than the specified time, the table to be predicted is specified as a table which will be vacant. That is, the number of customers seated which corresponds to the table identification information of the specified table is stored as zero. When it is determined that the time obtained by adding the predetermined staying time duration is later than the specified time, the controlling part 11 stores the number of the customers seated at the table being predicted as the value which is the same as the number of the customers seated at the table at the present. For the other tables, the controlling part 11 executes similar determination processing. Based on the calculated number of the customers seated at each table, the controlling part 11 calculates the vacancy rate, as in step S22.

At the processing of Step S24, the vacancy rate calculation apparatus 1 may transmit information indicating the number of customers that can be accepted by the restaurant to an external information providing device which is not illustrated. The controlling part 11 calculates the number of customers that can be accepted by the restaurant based on the information stored in the restaurant information storing part 16a and the table occupancy state information storing part 16b. Specifically, the controlling part 11 specifies table identification information of a vacant table based on the information stored in the table occupancy state storing part 16b. Then, the controlling part 11 specifies the number of acceptable customers, which is associated with the table identification information, based on the specified table identification information and the information stored in the table occupancy state information storing part 16a. That is, the number of customers that can be seated at a vacant table is specified. Further, when multiple pieces of table identification information are specified as vacant tables, the controlling part 11 determines whether or not multiple pieces of table identification information which are associated with the same group information are present. When it is determined that multiple pieces of table identification information are present, the controlling part 11 calculates the total number of acceptable customers which is indicated by the multiple pieces of table identification information which are associated with the same group information, as the number of customers that can be accepted by the restaurant. The controlling part 11 transmits the calculated number of customers that can be acceptable by the restaurant to the information providing device or a user's communication device.

Moreover, it may be configured that the number of customers that can be acceptable by the restaurant is calculated predictively and transmitted. In accordance with the above-mentioned procedure of the vacancy rate prediction, the controlling part 11 specifies the number of the customers seated at each table at a specified time and calculates the predicted number of customers that can be acceptable by the restaurant based on the specified table identification information and the seated number information and the information stored in the restaurant information storing part 16a. The method of calculating the predicted number of customers that can be acceptable is the same as the method of calculating the number of the customers that can be acceptable at the present time point.

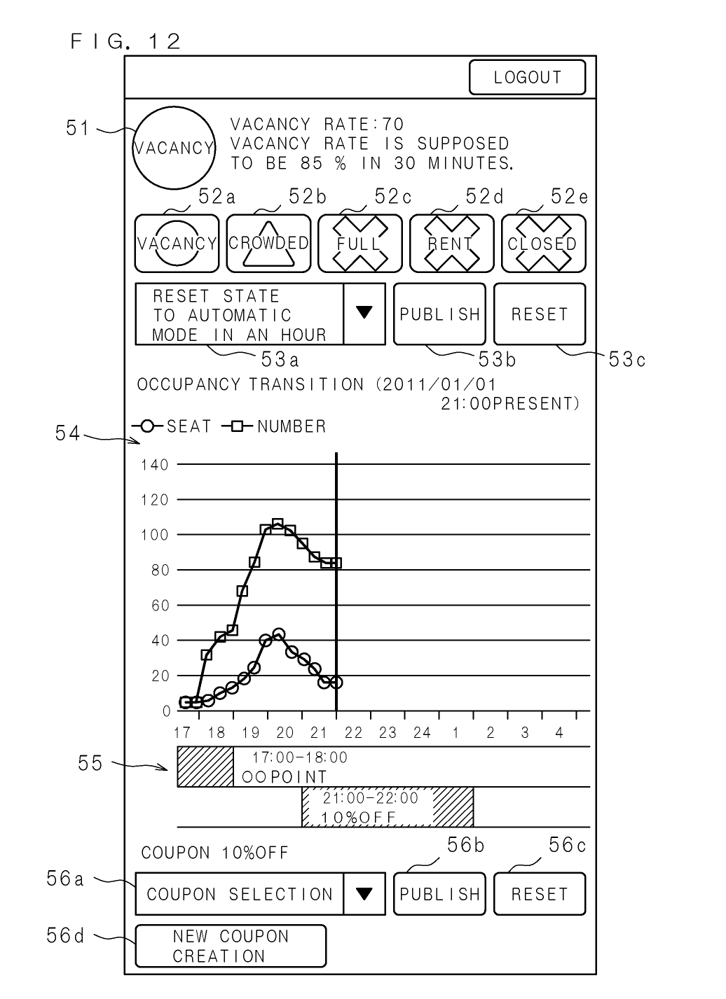

FIG. 12 is a diagrammatic representation illustrating an example of the display screen for indicating a vacancy rate or the like. At the upper part of the display screen for indicating a vacancy rate or the like, a vacancy rate icon 51 representing a vacancy rate is displayed. An administrator of the restaurant can, by selecting vacancy rate manual switching icons 52a, 52b, 52c, 52d and 52e and by operating a publishing button 53b, transmit the vacancy rate which is manually set to another information providing device, regardless of the vacancy rate calculated by the vacancy rate calculation apparatus 1. In this situation, the administrator can select from a setting duration menu 53a how many hours later the state which is set manually will be reset. By configuring the manual setting to be reset after a certain time, it is possible to avoid the situation that the occupancy state of the restaurant and the information provided from the information providing device become inconsistent with each other, which is caused by forgetting of reset. Further, the administrator can reset the manual setting of the vacancy rate at any timing by operating a reset button 53c.

Also, on the display screen for indicating a vacancy rate, a occupancy transition graph 54 indicating the total number of the customers currently present and the number of the tables currently used in the restaurant in real time. Under the occupancy transition graph 54, information of points, discount service or the like, which is offered at a certain period of time, is shown in a horizontal bar. The period of service time which is shown in the horizontal bar corresponds to a horizontal axis representing a time in the occupancy transition graph 54. The administrator of the restaurant selects various kinds of service contents from a coupon selecting menu 56a and issues various kinds of coupons, discount service through the information providing device by operating the publishing button 53b. It is also possible to cancel various kinds of coupons and discount service by operating a reset button 56c. Further, it is possible to register new various kinds of services by operating a new coupon creating button.

The period of service time shown by the horizontal bar under the occupancy transition graph 54 corresponds to the horizontal axis representing the time in the occupancy transition graph 54. Thus, it is possible to recognize the effect brought by various kinds of coupons and discount services at a glance.

In the vacancy rate calculation system, the vacancy rate calculation apparatus 1, the vacancy rate calculation method, and the computer program 17a which are configured as described above, when receiving customers with a plurality of tables 6 combined, it is possible to calculate a vacancy rate of a restaurant by only inputting table identifying information for one of a plurality of the tables 6 at which the customers are seated and the number of the customers.

General customers can predict the degree of busyness, the turnover of customers in the restaurant or the like based on information which is directly or indirectly provided from the vacancy rate calculation apparatus 1. As the administrator of the restaurant can grasp the number of customers, the number of the occupancy tables, the vacancy rate, sales, sales prediction, effect of various kinds of coupons, it is possible to operate the restaurant more effectively.

In a case where the restaurant is in a chain store-style business, it is possible to collect the vacancy rate, sales or the like of each of the restaurants and to operate each of the restaurants effectively.

In the present embodiment, an example is described that the communication device obtains table identification information indicating a table at which customers are seated and the seated number information from the OES and transmits the information to the vacancy rate calculation apparatus. The communication system at the restaurant is not limited to the OES and can be configured by any system as long as each of the information is transmitted from the restaurant to the vacancy rate calculation apparatus.

For example, in a system in which an OES function is realized by a plurality of tablet terminals wirelessly connected to each other, it may be configured that the tablet terminals receive an order and transmit the information directly to the vacancy rate calculation apparatus.

It should be understood that the embodiment described above is only illustrative but not limitative. The scope of the present invention is defined in the claims and includes all changes that fall within metes and bounds of the claims or equivalence of such metes and bounds thereof, but not limited to the above description.

1-5. (canceled)

6. A vacancy rate calculation apparatus comprising:
a restaurant information storing part for storing table identification information identifying each of a plurality of tables placed at a restaurant and the number of customers that can be seated at each of the plurality of tables, the table identification information and the number of customers that can be seated at each of the plurality of tables being associated with each other;
a receiving part for receiving table identification information indicating a table at which a customer or customers is/are seated and seated number information indicating the number of the customer or customers; and
a table occupancy state storing part for storing the table identification information and the seated number information received by the receiving part,
the vacancy rate calculation apparatus calculating a vacancy rate of the tables based on the information stored in the restaurant information storing part and the table occupancy state storing part, wherein
the restaurant information storing part stores group information indicating a group of a plurality of tables in which the plurality of tables are combined for allowing a plurality of customers to be seated together,
the vacancy rate calculation apparatus further comprising:
a part for determining whether or not the number of customers indicated by the seated number information received by the receiving part is equal to or less than the number of customers that can be seated at the table indicated by the received table identification information based on the information stored in the restaurant information storing part;
a part for determining, when it is determined that the number of customers indicated by the seated number information exceeds the number of customers that can be seated, whether or not another is vacant which can be combined with the table indicated by the received table identification information based on the group information stored in the restaurant information storing part and the information stored in the table occupancy state storing part; and
a part for causing, when it is determined that said another table which can be combined with is vacant, the table occupancy state storing part to store table identification information identifying said another table at which a customer is assumed to be seated, along with the received table identification information.

7. The vacancy rate calculation apparatus according to claim 6, comprising:
a part for determining whether or not another customer is already seated at the table indicated by the table identification information received by the receiving part based on the table identification information stored in the table occupancy state storing part;
a part for determining, when it is determined that another customer is already seated, whether or not a vacant table is present which can be combined with the table indicated by the table identification information received by the receiving part based on the grouping information and the table identification information stored in the table occupancy state storing part;
a part for exchanging, when it is determined that the vacant table is present, the table identification information indicating said another table stored in the table occupancy state storing part for the table identification information indicating the vacant table; and
a part for causing the table occupancy state storing part to store the table identification information and the seated number information received by the receiving part.

8. A vacancy rate calculation system comprising:
the vacancy rate calculation apparatus according to claim 6;
an order entry system for accepting table identification information indicating a table at which a customer or customers is/are seated, the seated number information indicating the number of the customer or customers, and an order of food and/or drink; and
a communication device for obtaining the table identification information and the seated number information from the order entry system and transmitting the obtained table identification information and the seated number information to the vacancy rate calculation apparatus.

9. A vacancy rate calculation method for calculating a vacancy rate of tables by using:
a restaurant information storing part for storing table identification information identifying each of a plurality of tables placed at a restaurant and the number of customers that can be seated at each the plurality of tables, and group information indicating a group of the plurality of tables in which the plurality of tables are combined for allowing a plurality of customers to be seated together; and
a table occupancy state storing part for storing table identification information indicating a table at which a customer or customers is/are seated and seated number information indicating the number of the customer or customers,
the vacancy rate calculation method comprising:
receiving table identification information indicating a table at which a customer or customers is/are seated and the seated number information indicating the number of the customer or customers;
determining whether or not the number of customers indicated by the received seated number information is equal to or less than the number of customers that can be seated at the table indicated by the received table identification information based on the information stored in the restaurant information storing part;
determining, when it is determined that the number of customers indicated by the seated number information exceeds the number of customers that can be seated, whether or not another table is vacant which can be combined with the table indicated by the received table identification information based on the group information stored in the restaurant information storing part and the information stored in the table occupancy state storing part; and
causing, when it is determined that said another table which can be combined with is vacant, the table occupancy state storing part to store table identification information identifying said another table at which a customer is assumed to be seated, along with the received table identification information.

10. A non-transitory computer-readable recording medium storing a computer program causing a computer to calculate a vacancy rate of tables, the computer comprising:
a restaurant information storing part for storing table identification information identifying each of a plurality of tables placed at a restaurant and the number of customers that can be seated at each of the plurality of tables, and group information indicating a group of the plurality of tables in which the plurality of tables are combined for allowing a plurality of customers to be seated together;
a receiving part for receiving table identification information indicating a table at which a customer or customers is/are seated and seated number information indicating the number of the customer or customers; and
a table occupancy state storing part for storing the table identification information and the seated number information received by the receiving part,
the computer program causing the computer to function as:
determining whether or not the number of customers indicated by the seated number information received by the receiving part is equal to or less than the number of customers that can be seated at the table indicated by the received table identification information based on the information stored in the restaurant information storing part;
determining, when it is determined that the number of customers indicated by the seated number information exceeds the number of customers that can be seated, whether or not another table is vacant which can be combined with the table indicated by the received table identification information based on the group information stored in the restaurant information storing part and the information stored in the table occupancy state storing part; and
causing, when it is determined that said another table which can be combined with is vacant, the table occupancy state storing part to store table identification information identifying said another table at which a customer is assumed to be seated, along with the received table identification information.
